(19) United States
(12) Patent Application Publication
(10) Pub. No.: US 2004/0164994 A1
(43) Pub. Date: Aug. 26, 2004

(54) Device system and method for displaying graphics in mixed formats on a monitor

(76) Inventor: Eran Leibinger, Kfar Saba (IL)

Correspondence Address: Eitan Pearl, Latzer & Cohen Zedek, Suite 101, 10 Rockefeller Plaza, New York, NY, 10020, US

(21) Appl. No.: 10/479,847

(22) PCT Filed:
(86) PCT No.: PCT/IL02/00444

(30) Foreign Application Priority Data
Jun. 7, 2001 (US) 60296177

(51) Int. Cl. G09G 5/02

(52) U.S. Cl. 345/603

(57) ABSTRACT

A device, system and method may input data in one or more graphics formats and output the data to a monitor, the monitor typically capable of displaying more than three primaries. The data formats are input, possibly converted or otherwise manipulated, and are output to a monitor. The monitor may be capable of displaying more than one format. One set of data may be displayed in a frame inset within the other set of data.

### FIELD OF THE INVENTION

The present invention relates to multi format display systems, more specifically the present invention relates to combining display formats such that the combined data may be displayed on a single display unit.

### BACKGROUND OF THE INVENTION

Color images can be presented on substrates such as slides, films, and paper, and also on electronic displays.

In a typical printing system, inks or dyes applied on a printing substrate behave as filters that pass only part of the white light spectrum. The light incident on the paper is spectrally filtered by the ink layer and reflected back towards the observer. Four types of inks are typically used, although of course other types of ink systems can also be used: Cyan (C), Magenta (M), Yellow (Y) and Black (K). Each of the primary inks blocks its complementary color, such that C passes green and blue and blocks red, M passes red and blue and blocks green and Y passes red and green and blocks blue. The black ink blocks the whole spectral range. Upon reflection from the paper surface only part of the spectrum arrives to the eye of the viewer, creating the sensation of a unique color. Color reproduction on paper involves subtractive color mixing. The term “subtractive” refers to the creation of color by removing a portion of the spectrum of light transmitted to the eye.

Most printing methods are binary in nature, namely an ink layer of a certain thickness is either present or absent on the paper surface. To obtain “gray levels” for each of the inks, halftone printing is typically used. Each of the inks is layered according to a virtual grid. The area of a grid cell is partially covered by ink according to the ink “gray level” required at that position. The relative area of the ink dot with respect to the grid cell size determines the “gray level” of the ink. This halftone printing technique results in an intricate set of small dense ink dots of different colors. When examining the printed paper at the usual viewing distance, the impression of color is achieved. However, looking at the printed paper through a magnifying glass resolves a delicate arrangement of dots in the original primary colors, and overlap regions of colors. The elementary colors, seen through the magnifying glass, include the four primaries CMYK, the three overlaps between two primaries giving Red (overlap of M and Y), Green (overlap of C and Y) and Blue (overlap of C and M), and the white color of the paper (see FIG. 1C).

Color may also be presented by electronic systems, for example by display devices such as computer monitors, televisions, computational presentation devices, electronic outdoor color displays and other such devices. These systems involve additive color mixing of, typically, three primaries: red, green and blue. The mechanism for color display may use various devices, such as Cathode Ray Tubes (CRT), Liquid Crystal Displays (LCD), plasma display devices, Light Emitting Diodes (LED) and projection devices. The term “additive” refers to the creation of color by combining light of at least two spectra before transmission to the eye. The spectra of “ideal” RGB primaries are shown in FIG. 1B, and the construction of other colors by additive mixing is shown in FIG. 1A.

As an example of the operation of such a device, CRT displays typically contain pixels with three different phosphors, emitting red, green and blue light upon excitation. In currently available displays, the video signal sent to the display typically specifies the three RGB color levels (or some functions of these levels) for each of the pixels.

Although color is a complex combination of physical and physiological phenomena, it has been found that colors can be approximately matched by combinations of only three colors, usually red, green and blue, a finding which has been exploited by various types of electronic display devices. These three colors are additive primaries. The match is perceptual, and depends on the processing of the spectrum of light arriving to the eye, by the human vision system and the brain. By combining different amounts of each color, a wide spectrum of colors can be produced. Nevertheless, not all colors can be produced by typical electronic display devices.

Print reproduction of color involves the creation of an accurate apparent color match between an original and a printed and typically mass produced reproduction. Color originals may be, for example, pictorial slides, which are analog in nature. They have a very large gamut, larger than typical reproduction systems, such as offset print. In the age of digital information most of the reproduction process is done digitally. For example, the original slide is scanned to obtain a file containing the color data in terms of RGB values (note such R, G and B may differ from the R, G and B of conventional monitors). The file is converted to CMYK separations, and then plates are created, which are installed on a press for print. To obtain color consistency, proofs are performed and examined in various stages of the process, to assure that each step is color consistent with its previous step.

In order to achieve good color match, the image is typically proofed by printing a “hard proof” on paper, and sending this paper “hard proof” to the customer and/or designer for approval. Upon approval, the proof is delivered to the printing shop, where the printer working on the press machine must then adjust the press machine until the printed sheets match the hard proof. This manual procedure limits the advantages of digital workflow. The need for an accurate digital “soft proof” on an electronic display is clear.

Currently available “soft proofing” devices enable designers and pre-press personnel to view the works on a computational device such as a personal computer or workstation displays (usually CRTs), while the final product is a printed image on paper. However, these background art devices do not overcome inherent deficiencies for digital print proofing, and in particular do not provide good color match, in the sense that they cannot accurately replicate the colors electronically as they would appear on the printed material. In particular, the color gamut of a typical CRT monitor (triangle B in FIG. 2) does not cover the whole gamut of printing processes (hexagon C in FIG. 2). This is a drawback, as many printed works are now transferred digitally from design to printed material over a network, and any procedure which must be performed through printing onto physical material, before the final printing step, significantly reduces the efficiency of the printing process.

File formats for print proofing applications typically correspond to the file formats for the print data itself, e.g., a CMYK format. On the other hand, most of handling of these files is often done on personal computers and work-stations, where the displays are standard monitors, typically based on RGB primaries. Therefore, a suitable conversion from original CMYK data to RGB signals suitable for presentation on conventional RGB display may be required, such conversion typically resulting in reduced color accuracy.

A more useful solution would enable a more accurate color display of material to be proofed, without conversion of input data from, for example, CMYK, to a format less effective for such proofing, such as RGB. Furthermore, it is desirable for such a display to also be able to display conventional material, such as computer generated displays of software programs such as Adobe Photoshop™ or operating systems such as Windows™, which are typically displayed via conventional RGB data being sent to a conventional monitor. It would be desirable to have a data handling system that could manipulate both data corresponding to proof image data, and data corresponding to conventional RGB data, and to coordinate the display of such data on a suitable monitor. Such solutions would, inter alia, enable a viewer to accurately determine the appearance of the image as printed on the material, such as paper, through an electronic display which may also be used for conventional display functions, such as interacting with software. It would further be desirable to have a system that could handle more than one type of display data

### SUMMARY OF THE INVENTION

Embodiments of the invention provide a device, system and method for inputting data in one or more graphics formats and outputting the data to a monitor, the monitor typically capable of displaying more than three primaries. The data formats are input, possibly converted or otherwise manipulated, and are output to a monitor. The monitor may be capable of displaying more than one format. One set of data may be displayed in a frame inset within the other set of data

### BRIEF DESCRIPTION OF THE DRAWINGS

FIG. 1A depicts the construction of additional colors by additive mixing;

FIG. 1B depicts the spectra of a set of “ideal” RGB primaries;

FIG. 1C depicts subtractive CMY primaries and the resulting overlaps;

FIG. 2 is a chart depicting the gamut produced by a typical conventional CRT display with RGB primaries and a gamut used to reproduce the colors produced by a set of printing inks;

FIGS. 3A and 3B are schematic block diagrams of embodiments of a display device and system for soft proofing;

FIG. 3c depicts the structure of an embodiment of a conversion unit used with an embodiment of the invention;

FIG. 4 depicts a device according to one embodiment of the present invention;

FIG. 5 is a schematic diagram depicting a signal output by a device according to an embodiment of the present invention;

FIG. 6 describes a displayed image produced by a monitor used with an embodiment of the present invention;

FIG. 7 depicts a device according to one embodiment of the present invention;

FIG. 8 depicts an embodiment of a network that may be used with devices according to an embodiment of the invention; and

FIG. 9 is a flow chart illustration of a method of combining data of a plurality of formats in accordance with an embodiment of the present invention

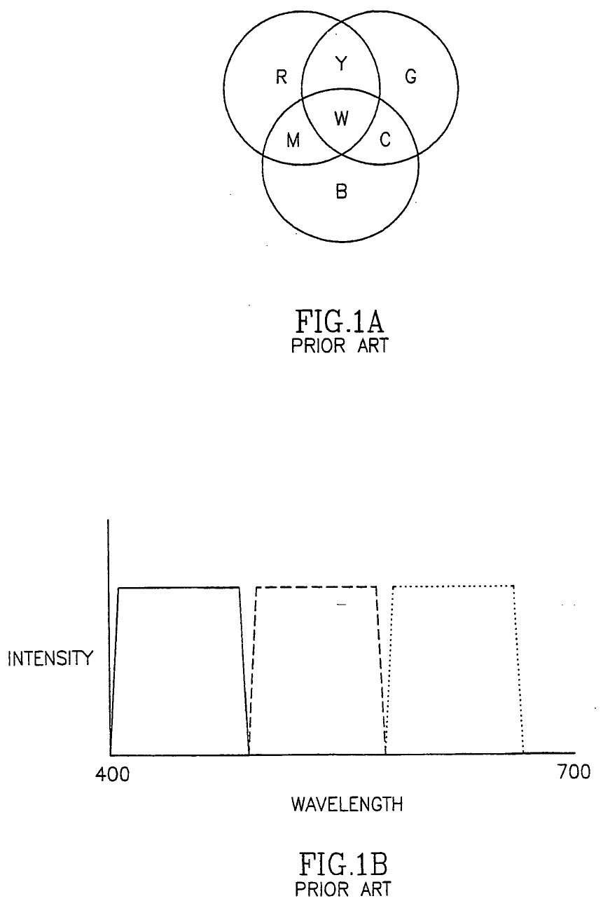

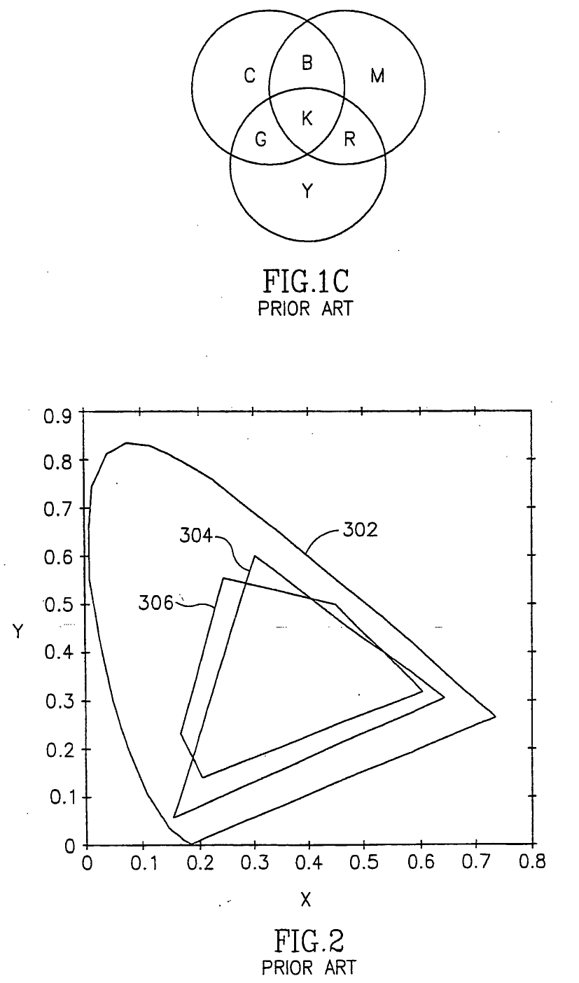

### DETAILED DESCRIPTION OF THE INVENTION

Various aspects of the invention are described, with reference to specific embodiments that provide a thorough understanding of the invention; however, it will be apparent to one skilled in the art that the present invention is not limited to the specific embodiments and examples described herein. Further, to the extent that certain details of the systems and methods described herein relate to known aspects of digital image and video processing, such details may have been omitted or simplified for clarity.

Embodiments of the present invention may include apparatuses for performing the operations herein. Such apparatuses may be specially constructed for the desired purposes (e.g., a “computer on a chip” or a graphics processor chip or card), or may comprise general purpose computers selectively activated or reconfigured by a computer program stored in the computers. Such computer programs may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

Unless specifically stated otherwise, as apparent from the following discussions, it is appreciated that throughout the specification discussions utilizing terms such as “processing”, “computing”, “calculating”, “determining”, or the like, typically refer to the action and/or processes of a computer or computing system, or similar electronic computing device (e.g., a “computer on a chip” or a graphics processor chip), that manipulate and/or transform data represented as physical, such as electronic, quantities within the computing system's registers and/or memories into other data similarly represented as physical quantities within the computing system's memories, registers or other such information storage, transmission or display devices.

Embodiments of the device, system, and method of the present invention input data in one or more graphics formats and output the data to a monitor, typically a monitor suitable for print proofing and able to reproduce spectra produced by a print process. In one embodiment, a data handling unit, such as a card in a personal computer, or a workstation, receives data in two graphics data formats, possibly converts or otherwise manipulates the data, and outputs the combined data to a monitor. Typically, the monitor is attached to the personal computer or workstation. In another embodiment, such a data handling unit receives one or more data formats, possibly manipulates the data formats, and transmits the data across a network to a central monitor.

Typical personal computers and workstations include processing intensive graphics capabilities such as 3-D manipulation which process conventional RGB data and transmit such data to monitors, typically via high speed connections. Embodiments of the present invention allow for the manipulation of an alternate format of data which, typically, does not require such processing intensive graphics capabilities. Therefore, such embodiments may accept conventional RGB data, on which graphics processing may have been performed by the personal computer or workstation or by, for example, graphic accelerators on graphic cards, and, without significant further processing, combine the data with the alternate format for output to a monitor.

I. Monitors Used with Embodiments of the Device, System and Method of the Present Invention

Embodiments of the present invention provide data to a monitor which typically uses more than three primary colors. For example, International Application PCT/IL01/01179, discussed below, describes embodiments of a device, system and a method for soft proofing of an image before it is printed onto printed material. Such embodiments can typically display a wider gamut of colors and data corresponding to such wide gamut colors, and/or typically use n>3 primaries. Such embodiments can also typically display both colors displayed by conventional displays (e.g., displays using conventional RGB data and conventional RGB primaries), and colors generated from n>3 primaries. Data may need to be converted from conventional data (e.g., RGB data) to a suitable format before being displayed by such a monitor; alternately, such a monitor may perform such conversions.

A display system used with one embodiment of the invention may have an expanded range of colors, due to the use of more than three primaries. A monitor with more than three primaries can be constructed to reproduce improved color images.

Embodiments of monitors based on more than three primaries are disclosed in International Application PCT/IL01/00527, entitled “Device, System and Method For Electronic True Color Display,” filed Jun. 7, 2001, and published Dec. 13, 2001 as WO 01/95544, assigned to the assignee of the present application, the entire disclosure of which is incorporated herein by reference, and International Application PCT/IL01/01179, entitled “Spectrally Matched Print Proofer,” filed Jun. 7, 2001, assigned to the assignee of the present application, the entire disclosure of which is incorporated herein by reference. Wile the methods and systems disclosed in these patent applications may be used in or with embodiments of the present invention, the system and method of the present invention may also be embodied in conjunction with other n-primary color display technology, wherein n is greater than or equal to three, or with other display technology.

FIG. 2 is a chart depicting the gamut produced by a typical conventional CRT display with RGB primaries and a gamut used to reproduce the colors produced by a set of printing inks. Referring to FIG. 2, the horseshoe A represents the gamut generally viewable by humans. Triangle B represents the typical range of a prior art display, using three primaries such as RGB. The area enclosed by the hexagon C represent the typical range of colors achievable by CMYK process inks. A display having chromatic coverage more suitable for print proofing may be achieved by using, for example, the coverage described by area C, and in addition, typically, triangle B. Other monitors, having other sets of primaries, may be used with embodiments of the present invention

The term “primary color” specifically does not include light from a white or polychromatic light source after only being passed through a neutral filter. Thus, unlike background art systems and devices, embodiments of the present invention are not limited to combinations of colors which are produced from only three primary colors, such as red, green and blue, for example. However, embodiments of the present invention may be used with monitors displaying only conventional primaries.

In typical embodiments of such a monitor, 3, 4, 6 or 7 primaries are used. In one embodiment, the displayed image is displayed with at least 3 to 7, and typically more than 3, primary colors. However, in other embodiments, other numbers of primaries may be used. In an embodiment used for proofing, the monitor may mimic the spectrum of the light arriving to the eye of the observer from printing on a substrate, thus helping to provide a substantial or exact color match at the spectral-level. Thus, the colors of the electronically displayed image can be accurately spectrally matched to the colors of the printed material.

A set of primaries may spectrally reproduce a set of spectra. A good spectral match may be produced by a small numbers of primaries; for example three or four display primaries may be used to reproduce spectrally the spectrum of inks and overlaps. Regardless of the number of primaries, the primaries included need not individually match the spectra reproduced.

An electronic display device used with embodiments of the invention typically operates with a projective light mechanism for projecting the light onto display screen. The device includes a component for controlling the color of light which is displayed on each portion of the display screen, and thereby modulating the colors of the display. In alternate embodiments of the system and method of the present invention, primary colors may be produced by other methods, such as LCDs or LEDs.

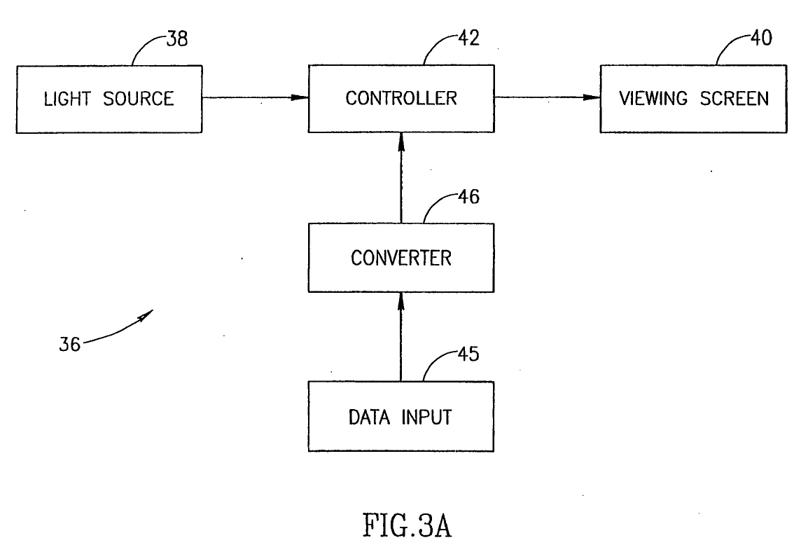

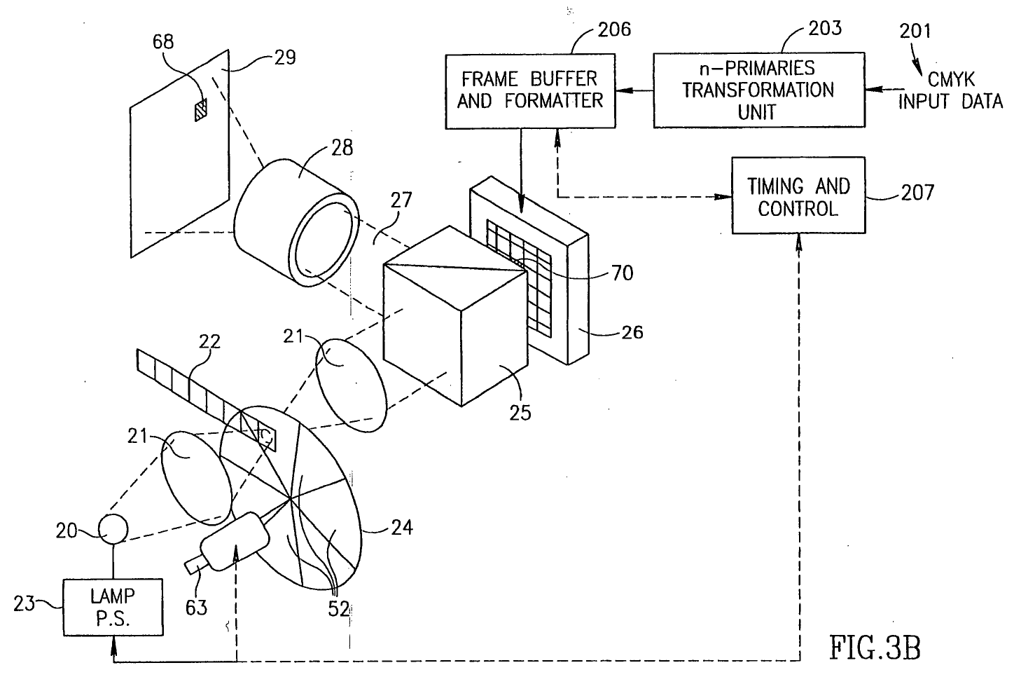

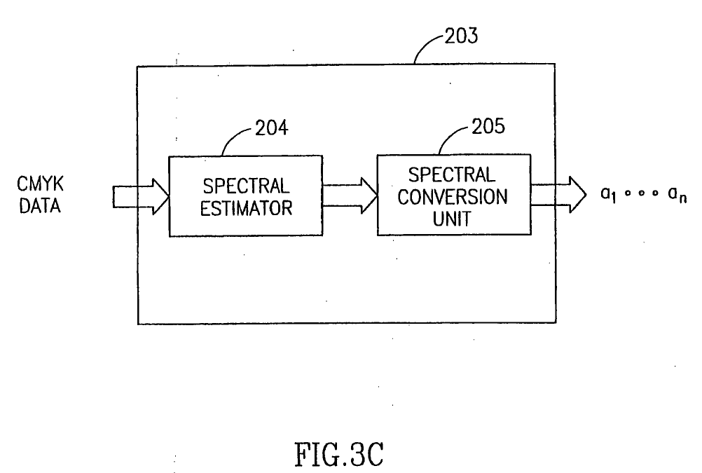

FIGS. 3A and 3B are schematic block diagrams of embodiments of a display device and system for electronic soft proofing. FIG. 3A shows a basic embodiment, while FIG. 3B shows an embodiment featuring a light projection mechanism. Note that the system and method of the present invention may be used with displays not used for proofing, displays not capable of n>3 primary display, and displays other than those described in the above mentioned International Applications. For example, the system and method of the present invention may be used with displays capable of displaying more than one format of display data. Such multi format displays may include the capability to convert formats to a standard, displayable format, and/or may include enough primaries to handle more than one input format.

As shown in FIG. 3A, a system 36 according to one embodiment features a light source 38 for producing light of preferably 4-7 elementary colors; other numbers of primaries, such as 3, may be used. In an embodiment using seven colors, these colors may be C, M, Y, R, G, B and white, corresponding to the elementary colors of inks and overlaps in printing. Alternately, the colors may be fitted in transmission spectrum to that of a certain set of inks and paper under certain illumination conditions. Note that the R, G, and B may not correspond to the R, G, and B typically used in conventional displays. In one embodiment, one filter or primary source is used for each primary; in alternate embodiments lower numbers of primaries may be mixed in the proper proportions to reproduce with some accuracy a higher number of transmission spectra colors. The light from light source 38 is displayed on a viewing screen 40, thereby enabling the viewer to see the colors of the displayed image (not shown). Preferably, the light from light source 38 is projected onto viewing screen 40. In order for each color to be properly displayed in the correct location of the displayed image, a controller 42 controls the production of light of each color, such that the correct light is shown at the correct location of viewing screen 40. In alternate embodiments of the system and method of the present invention, primary colors may be produced by other methods, such as backlit LCDs or LEDs.

In one embodiment of system 36, light source 38 projects light of at least 3 to 7 colors, without being able to control the location of the projected light onto viewing screen 40. Controller 42 then determines the relative location of light of each color as projected onto viewing screen 40, for example with a spatial light modulator and/or a system of mirrors and/or lenses.

In order for controller 42 to be able to determine the correct light for being displayed at each portion of viewing screen 40, controller 42 optionally receives data from a data input 45, which may optionally be digital or analog. Most preferably, controller 42 also receives instructions and/or commands from a converter 46, which lies between data input 45 and controller 42. Converter 46 converts the data from data input 45 into a format which is suitable for controller 42, and also includes any necessary instructions and/or commands for enabling controller 42 to be able to understand the data. Converter 46 may be implemented in software, hardware, or a combination thereof. Optionally, converter 46 may also convert the data from an analog signal to digital data, such that controller 42 is only required to receive digital data.

Preferably, converter 46 is able to determine the appropriate combination of primaries in order to accurately represent the color image data with displayed colors which spectrally match or substantially spectrally match the colors of a certain printed material, such that the appearance of the displayed image matches or substantially matches the appearance of a certain set of inks as printed onto the paper of the printed material. In alternate embodiments, a monitor used with an embodiment of the invention need not be geared towards print proofing.

In alternate embodiments, converter 46 is able to determine the appropriate combination of light of another number of primary colors in order to accurately represent a set of ink transmission spectra. For example, three or four primaries may be combined to reproduce seven transmission spectra. In other embodiments, other numbers of transmission spectra may be reproduced, for example if proofing for ink systems producing different numbers of transmission spectra are desired to be created.

FIG. 3B shows an embodiment of a display device meant to be used with a device, system and method according to an embodiment of the present invention. A system 48 is based on a sequential light projection system, similar in certain respects to that suggested in U.S. Pat. No. 5,592,188, which is hereby incorporated by reference, as if fully set forth herein. System 48 according to one embodiment may pass white or substantially white light from a source 20 through a spectrum-correcting filter 22 in order to attempt to match the spectrum of the light to at least one of the relevant required illumination conditions and the relevant paper (or other printing substrate) reflectance spectrum; filter 22 need not be used.

The brightness of the light is optionally and preferably controlled by adjusting the amount of power supplied by a power supply 23 or by a variable neutral density filter. The light passes through appropriate color filters 52 to form colored light of a defined spectral range. As previously described, system 48 preferably uses at least 3 to 7 such colored filters 52, which as shown may optionally be configured in a color filter wheel 24, but may optionally include other numbers of filters or primaries. In further embodiments, primaries are reproduced using methods other than filters; for example, different LEDs may provide primaries.

In order for the light to be directed through the appropriate filter 52, typically the light is focused by a condenser lens 21, optionally implemented as two such lenses 21, without being limiting. In alternate embodiments, various components, such as the condenser, may be eliminated. The focused light is then directed through one of the filters on filter wheel 24, which holds the color filters 52.

Preferably, the colored light illuminates a spatially modulated mask 26, also known as an SLM (spatial light modulator). For example, a digital micro-mirror device (DMD) by Texas Instruments or Ferroelectric Liquid Crystal (FLC) SLM by Displaytech and other vendors may be used.

The colored light for this image is then projected by a projection lens 28 onto a viewing screen 29. In the implementation depicted, based on a reflecting LCOS device for spatially modulated mask 26, a polarizing cube beam splitter 25 may be included from which polarized light 27 is transmitted to projection lens 28. Viewing screen 29 displays the resultant colored image to the user (not shown).

Preferably, a motor 63 rotates filter wheel 24 in front of light source 20, so in each turn spatially modulated mask 26 is illuminated by the colors in filter wheel 24 sequentially. Preferably the rate of rotation is at the frame frequency, which is the frequency at which the full-color image on viewing screen 29 is refreshed.

The values for the pixels of the image are typically retrieved from an image data file 201. The data may be transformed by an n-primary transformation unit 203 to n-primary color channels. The n-primary color channels may be subjected to correction such as a gamma correction process. The data channels are formatted and loaded through frame buffer and formatter 206 one after the other into spatially modulated mask 26. Preferably, the loading of the data into spatially modulated mask 26 is synchronized by a timing system 207, according to the rotation of filter wheel 24. The Light beam is spatially modulated by spatially modulated mask 26, so that the apparent brightness of each primary color varies at different portions of viewing screen 29, typically according to each pixel of the image. Each position 68 on viewing screen 29 is preferably associated with a certain pixel 70 in spatially modulated mask 26. The brightness of that position is determined by the relevant data pixel in the image.

The human viewer integrates the sequential stream of the primary images to obtain a color image which spectrally matches or substantially spectrally matches the image on paper. In further embodiments, other methods of producing primaries and displaying primaries may be used, and other light delivery mechanisms using different sets of components may be used. For example, an SLM need not be used.

A monitor which may be used with embodiments of the present invention may accept print file data, such as CMYK data, and convert such data to a suitable format, such as a set of constants for each pixel determining the proportion of primaries to be displayed for that pixel. In another embodiment, a card or processing device according to an embodiment of the system and method of the present invention may perform such conversion and transmit to the monitor the primary information. In other embodiments other input data may be accepted by the monitor, having other forms or formats.

The data sent to such a display or device may be in, for example a CMYK format (other formats of data may be used); such data is converted via a series of steps to data for the set of primaries used in the display. The implementation of the processing from input data to display primaries can be done in software or hardware (e.g. units 920, 120 and 150 described below or unit 203). Furthermore, such transformations may transform data other than CMYK data: for example, conventional RGB data may be transformed to a set of primary levels appropriate for a certain display. The display or device may also accept print process parameters or other information used to adjust the conversion, e.g. dot gain.

The structure of an embodiment of a conversion unit used with an embodiment of the invention is shown in FIG. 3c. Referring to FIG. 3c the input data may be processed by a spectral estimator module 204, which evaluates the spectrum at each of the pixels according to, for example its CMYK values. This spectral evaluation may be based on typical spectra of printing inks (known beforehand), and other process parameters, which are measurable in the print shop, including, e.g. dot gain. The evaluation may be based on other data. In alternate embodiments, a spectral evaluation need not be done, such as in the case that a set of spectrum to be reproduced are input or in the case that other data, such as if conventional RGB data is input for conversion.

A spectrum φ(λ) corresponding to a certain CMYK data can be presented as a set of numbers φᵢ₌φ(λᵢ) each representing the appropriate value for a certain wavelength λᵢ, where the points λᵢ may be uniformly or non-uniformly spread through the visible range (usually between 400-700 nm). Alternatively the spectrum can be represented as a set of coefficients βⱼ representing the weights of predefined spectral basis functions Ψⱼ(λ), namely:

φ(λ)=G(ΣβⱼΨⱼ(λ)) (1)

where G(x) is a pre-defined function. Typically, the second method is used, since description in terms of spectral basis functions requires smaller number of coefficients and therefore less memory and less calculations. Furthermore, cleverly chosen set of basis functions can reduce the problem of spectral estimation to simple manipulation of the CMYK values, namely that the coefficients βⱼ are derived directly from the CMYK values using simple arithmetic as discussed below.

The spectrum calculated by the spectral estimator 204 of FIG. 3c may be created as positive linear combinations of the display primaries, namely:

$$ϕ ( λ ) ≅ {\sum }_{k = 1}^{n} {a}_{k} {X}_{k} ( λ ) \qquad ( 1 a )$$

Here χₖ(λ) is the spectra of the display primaries and φ(λ) is the spectrum to be reproduced. The spectrum, in either wavelength or basis weights representations, may be transformed to coefficients that represent the weight of each of the display primaries a₁ . . . aₙ by a spectral conversion module 205 of FIG. 3c. The calculated coefficients a₁ . . . aₙ of the display primaries are used as the signals for the display itself.

In the special case that the basis functions Ψⱼ(λ) are identical to the display primaries χ_{κ}(λ), the spectral conversion module can be omitted, since the basis weights coefficients can be used as the signals for the display primaries. In any case, a suitable choice of the basis function and the display primaries allows for a simplification of the conversion module, namely the conversion module can be reduced to an n×m matrix, where n is the number of display primaries and m is the number of basis functions. For the given basis function Ψⱼ(λ) we can write:

$${ψ}_{j} ( λ ) ≅ {\sum }_{k = 1}^{n} {c}_{jk} {X}_{k} ( λ ) \qquad ( 1 b )$$

Since both the basis functions Ψⱼ(λ) and the display primaries χ_{κ}(λ) are known the values cⱼₖ can be calculated and stored. Then for linear models, where G(x)=x the values ai of eq. 1a can be calculated by inserting eq. 1b into eq. 1 and comparing it with eq. 1a to obtain:

$${a}_{k} = {\sum }_{j = 1}^{m} {β}_{j} {c}_{jk} \qquad ( 1 c )$$

Eq. 1c represents a matrix multiplication of the vector b by the matrix C⁺, where C⁺ is the transposed matrix of C. C+is an n×m matrix as indicated above. Examples of models that can be performed by the spectral estimator module include Murrey-Davis' spectral Neugebauer model, Yule-Nielsen spectral Neugebauer model Cellar spectral Neugebauer model and others. The Murrey-Davis spectral Neugebauer model estimates the spectrum of a CMYK pixel by:

$$ϕ ( λ ) = {\sum }_{i} {F}_{i} {R}_{i} ( λ ) \qquad ( 2 )$$

Here φ(λ) is the estimate of the spectrum reflected from the substrate, and Rᵢ(λ) are the spectral reflectivity of a set of elementary colors, for example i=RGB CMY KW. Rᵢ(λ) depends on the illumination conditions and substrate properties via Rᵢ(λ)=S(λ)R_{W}(λ) Tᵢ(λ), where S(λ) is the spectrum of the incident light, R_{W}(λ) is the reflectance of the white paper (other substrates may be used) and T₁(λ) is the transmission of the i^{th} elementary color (ink or overlap of inks). It is usually assiuned that the transmission of black layer T_{κ}(λ) is zero or nealigible over the whole spectral range, however, correction for finite small transmission can also be implemented. Other functions may be used, with different of omitted factors.

The relative values of the composition Fᵢ may be given by the Demichel equations (other equations may be used, and other colors and spectra may be used):

F_{C}=C(1−M)(1−Y)(1−K)

F_{M}=M(1−C)(1−Y)(1−K)

F_{Y}Y(1−C)(1−M)(1−K)

F_{R}=MY(1−C)(1−K)

F_{G}=CY (1−M)(1−K)

F_{B}=CM(1−Y)(1−K)

F_{K}=K+CMY(1−K)

F_{W}=1−Σ_{i≠W}Fᵢ (3)

Here C, M, Y and K are the respective dot areas of the relevant pixel as measured on substrate (typically after dot gain correction). Typically, the spectra produced by the black ink used in the printing process does not differ from that produced by an overlap of the C, M and Y inks; however, implementations where the spectra differ, where the blacks differ, are also possible. In such implementations, more Neugebauer values and primaries may be used to represent the blacks.

In terms of Eq. 1 the reflection spectra Rᵢ(λ) are equivalent to the basis function Ψᵢ(λ), the parameters Fᵢ are identical to the coefficients βᵢ, and G(x)=x.

For Yule-Nielsen spectral Neugebauer model eq. 2 is replaced by:

$$ϕ ( λ ) = {\{ {\sum }_{i} {F}_{i} {R}_{i}^{1 / n} ( λ ) \}}^{n} \qquad ( 4 )$$

Here n is an empirical parameter, that for offset print is found in the range of 1.5-2. In terms of equation 1, the basis functions Ψᵢ(λ), are equivalent to Rᵢ¹ⁱⁿ(λ), and equivalent to Rᵢ¹ⁱⁿ(λ) and G(x)=xⁿ.

For a Cellular Neugebauer model eq. 2 holds, however more basis functions are used in intermediate CMYK values (not only at 100% values of the primaries and their overlaps). Fᵢ are calculated in each of the cells with respect to the corners of the cube enclosing the input point.

Input data such as RGB for conventional monitors can be converted to a₁ . . . aₙ for the n-primary (where n is typically greater than 3) monitor via, for example, n×3 matrix. The color of the R primary of a conventional monitor can be created by a linear combination of the display primaries Σc_{Rk-χk}(λ) and similarly for the G and B primaries of conventional monitor. Thus a conversion from RGB input to for n-primaries monitor is given by:

$$( \begin{matrix}{a}_{1} \\ . \\ . \\ . \\ {a}_{n}\end{matrix} ) = ( \begin{matrix}{c}_{R1} & {c}_{G1} & {c}_{B1} \\ . & . & . \\ . & . & . \\ . & . & . \\ {c}_{Rn} & {c}_{Gn} & {c}_{Bn}\end{matrix} ) ( \begin{matrix}R \\ G \\ B\end{matrix} )$$

II. Embodiments of the Device, System and Method of the Present Invention

In one embodiment of the device, system, and method of the present invention a data handling unit, such as a card in a personal computer, or a workstation, receives data in two graphics data formats, possibly converts or otherwise manipulates the data, and outputs the combined data to a monitor. Typically, the monitor is attached to the personal computer or workstation. Using standard graphic cards, the computer or work-station is typically capable of sending only three-channel video output to a monitor. However., a more-than-three-primaries monitor described above may use more than three signals (for example CMYK). Thus a specialized graphic card is used to connect the computer with the more than n-primaries monitor. However, since the monitor may also present RGB data, this specialized graphic card should also support complicated 3-D graphic processing performed for example by graphic acceleration on standard EGB graphic cards.

An embodiment of the device, system and method overcomes the problem of the complicated RGB processing by accepting RGB data which may have had graphics processing such as 3-D processing, performed on it by e.g. a standard RGB graphic card supporting this processing. This eliminates the need for further such processing in a device accepting, for example, print data for conversion to a format suitable for a monitor displaying both sets of data.

A device, system or method accepts conventional video data, such as RGB data, and converts this data to a format suitable for display on a monitor, such as a set of signals, each signal corresponding to a primary in the monitor, where the number of primaries is typically greater than three. Such conversion may be performed, for example, via a matrix operation as described herein; other methods and calculations may be used. Such a conversion from RGB data to a suitable set of coefficients may be performed, for example, by the matrix operation described above; in alternate embodiments other methods may be used.

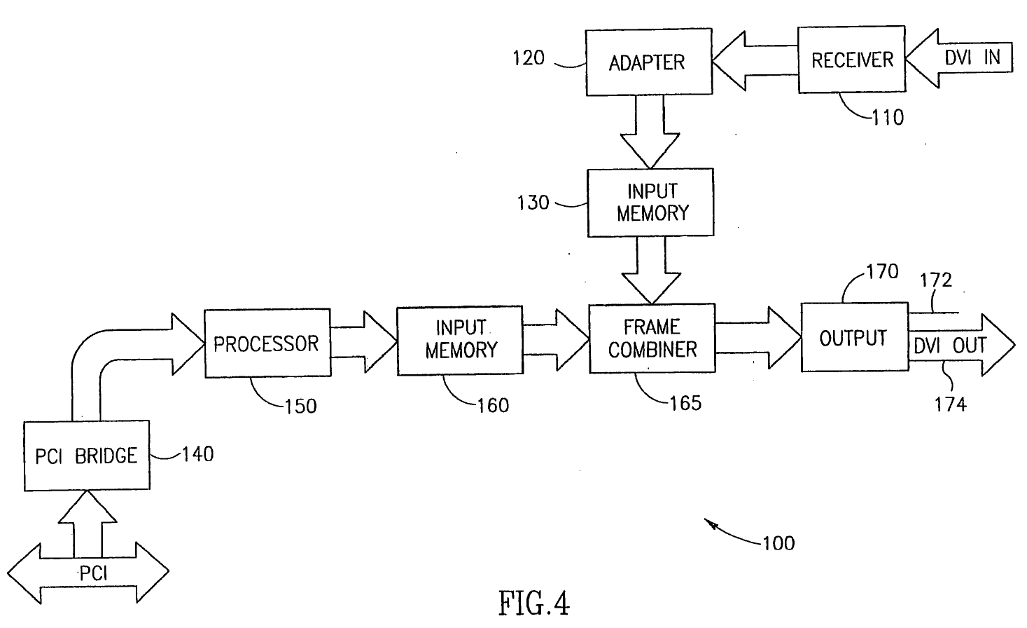

FIG. 4 depicts a device according to one embodiment of the present invention. In one embodiment, device 100 including the various units depicted in FIG. 4 are in a card or processing system, such as a card that may be inserted into a personal computer, workstation, or other system. In another embodiment, such units may all be part of a personal computer, workstation, or other system, containing traditional computer subcomponents such as a disk drive, processor, memory, etc. In such a case, all or some of the units may be implemented in hardware, and all or some of the units may be implemented in software. For example, in one embodiment, all of the units may be implemented as a software program running on a conventional personal computer, which outputs data to a monitor capable of accepting such data. The functionality of such a device 100 may be achieved using other systems. For example, the functionality may be divided among different physical or software units.

Referring to FIG. 4, device 100 includes a unit or units capable of inputting and/or processing a first data format. Device 100 includes a data receiver 110 which may accept a data stream representing video information, in either digital or analogy format, and convert such video data to a format used for processing. In one embodiment, data receiver 110 is a DVI receiver, such as those based on PanelLink® technology from Silicon Image Inc. capable of receiving DVI data and converting the DVI data to, for example. RGB data (e.g. 3×S RGB data). In other embodiments, other RGB formatted data may be received by data receiver 110 and converted to RGB data; alternately, non-RGB data may be received and converted.

Format adapter 120 accepts data from data receiver 110 and converts the data to a format suitable for a monitor such as that described in FIGS. 3a and 3b. In one embodiment, format adapter 120 converts RGB data to a set of primary levels suitable for an n>3 primaries display, as described above; in other embodiments other conversions and formats may be used. Input memory 130 accepts and temporarily stores the data from format adapter 120. In alternate embodiments, no data conversion need be performed from the data output by data receiver 110.

The first format of data may require graphics processing, such as 3-D processing, and an additional format of graphics data accepted by the device 100 may not need such processing. Since graphics processing may have been already performed on the first format of data by the personal computer or workstation before the data is sent to device 100, device 100 may not require such complex graphics processing capabilities.

Device 100 includes a unit or units capable of inputting and/or processing a second data format. PCI bridge 140 enables the transfer of a second format of data to the device 100. In one embodiment, such a second format is a source data of a different format, such as CMYK data. In alternate embodiments, other methods of transferring data to device 100 may be used, and the second format need not be source data for CMYK data. Format processor 150 converts the second format data to data suitable for the relevant monitor. In one embodiment, such a conversion is from source data, such as CMYK data, to a set of primary levels suitable for an n>3 primaries display, as described above; in other embodiments, other data formats may be used. As discussed above, such data conversion may be performed in the monitor itself. Format adapter 120 and format processor 150 may implemented in a number of ways; for example, via an ASIC or FPGA or other computing device, in software, or by other methods.

Input memory 160 accepts and temporarily stores the data from format processor 150. Input memories 130 and 160 may be similar to the frame buffer memory typical graphic cards. In alternate embodiments, the sources for the data may be other sources, such as from a data network.

Frame combiner 165 accepts data from input memory 130 and input memory 160, and combines the data to, typically, one frame of data per each display cycle of monitor. Typically, position data or a frame parameter is included and transferred to the frame combiner. Such position data or frame parameters determine where, on the overall first format display field, the second format data is to be displayed. For example, such position data may be two coordinates defining a rectangle for the display of the second format data. In one embodiment, an operating system and/or a software application determine the position and size of the frame for one of the data formats. In alternate embodiments, no position data may be needed, position data may be transferred in another manner, or position data for both the first and second format data may be used. The frame combiner 165 may work according to conventional frame combiner methods, such as those providing picture in picture features on monitors.

Device 100 includes a unit or units capable of outputting the data formats, possibly combined. Output unit 170 accepts data from the frame combiner and outputs the data to the monitor via for example, data lines 174. Output unit 170 may output. For example, DVI data corresponding to n primaries, where n>3. Other formats may be used. For example, the device 100 may manipulate and combine conventional RGB data with data produced by medical imaging devices, for simultaneous display on a suitable monitor.

In embodiment where all data is converted to a format appropriate for the monitor, the monitor simply accepts all converted data, and does not distinguish between the different formats of data that entered the device 100. In an alternate embodiment all data is not converted within the device 100, and thus data of different formats is sent to the monitor. In such an embodiment, a signal is output to monitor, typically via output unit 170, which indicates to the monitor which data format is currently being output. For example, in one raster line, when data of a first format is being output, the signal may be in one state, and when the data in the Line switches to a second format, the signal switches to a second state. Such a signal may be output via optional a control line 172.

In an embodiment where the data formats are output in separate formats, different numbers of signal lines may be used with each fomat. For example, device 100 may include 4 signal lines and a control line. When a CMYK signal is sent, each component is sent on one signal line, and the control line indicates that a CMYK file is sent. When RGB data is sent, only 3 of the 4 signal lines are used and the control line indicates RGB data. In another embodiment 6 or 7 signal lines are sent, for CMYRGB or for CMYKRGB formats, or where each signal line corresponds to a display primary. Other numbers of signal lines may be used.

Personal computer and workstation graphic applications (e.g. video players, games, operating systems interfaces) are typically based on conventional RGB data. Such applications may utilize complicated 3D capabilities of graphic display cards. It is desirable that these enhanced features are displayable on a monitor accepting data in more than one format. However, an additional format (e.g., CMYK based data) may not require these features. In one embodiment, in order to avoid the need for conversion between formats, when sending the data to the monitor, it may be desirable to send each of the two formats relatively “as is” and unconverted. In such a case, a standard graphic display card is used for one format; for example RGB data The output of this standard card enters an embodiment of the device 100 via the receiver 110. The data of a second format (such as CMYK data, medical imaging data, or high gamut data), is received for example via the data bus of a personal computer or workstation using the PCI bridge 140. The device 100 therefore may not require 3D or capabilities which may not be required for the second format.

In one embodiment, the device 100 accepts print data, such as CMYK data, and converts this data to a format suitable for display on a monitor, such as a set of signals, each signal corresponding to a primary in the monitor, where the number of primaries is typically greater than three. Such conversion may be also be performed by the monitor itself, in which case the print data may be sent directly to the device 100. Furthermore, in alternate embodiments, data in other formats may be accepted, manipulated, and passed on to a monitor. For example, other data requiring conversion to n>3 primaries data may be accepted, or other data not requiring conversion (which is simply passed on), or other data which is not ultimately displayed in an n>3 primaries format. Furthermore, other methods of transforming data may be used.

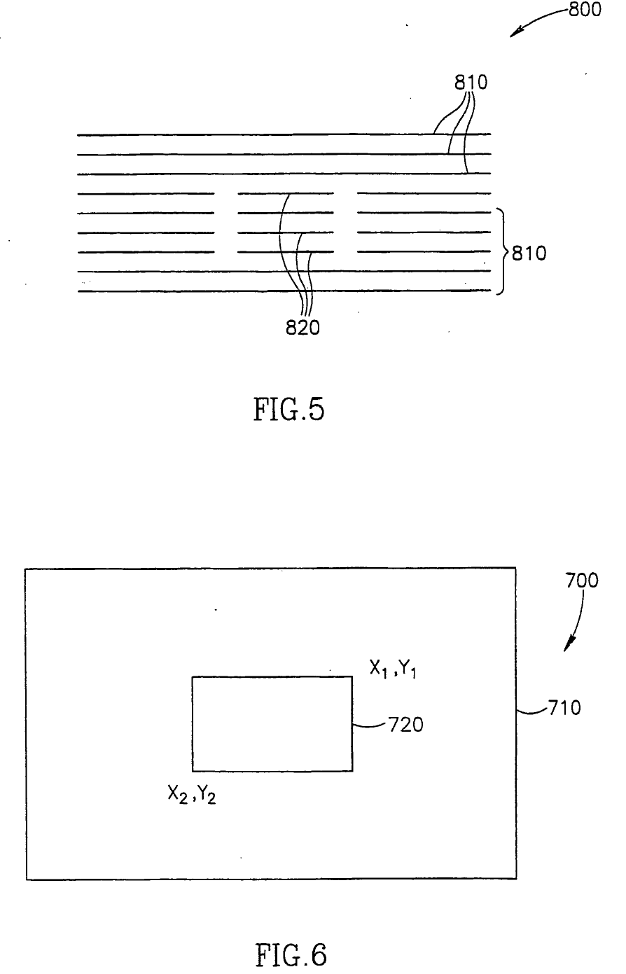

Typically, the data is output by output unit 170 in raster format. Thus, each tine of data output may be only of the first format, only of the second format, or a combination thereof. Typically, the data is output serially, and each pixel of each line is output as either data from the first format or data from the second formal. Thus at each point in time, either data from the first or data from the second format is output. The two formats may be output in one standardized format, each datum (e.g. pixel) containing data originating with one of the two formats. FIG. 5 is a schematic diagram depicting a signal output by a device according to an embodiment of the present invention. Raster lines 800 are output in a first format, corresponding to lines 810. A second format is output, typically in an inset format, corresponding to lines 820. The two formats may be output as: for example, different data formats (e.g., conventional RGB data and CMYK data), or as one standardized format (e.g., n>3 primaries data).

FIG. 6 describes a displayed image produced by a monitor used with an embodiment of the present invention. Data of one format is to be combined with data of a second format, and displayed at a certain position on the monitor. Referring to FIG. 6, monitor 700 displays a portion 710, generated by data of the first format. Within portion 710 is a window 720 displaying data in the second format.

In one embodiment, in use, a processing device such as a personal computer or workstation runs software which outputs and manipulates two formats of display data; for example, conventional RGB data and CMYK data. Such software may be, for example, graphics arts proofing software, where the conventional data is display data for typical user interface controls, such as windows, menus, text, etc, and where a second set of data is data corresponding to the document to be proofed. The software may, per user control, control the output of second set of data within frames of conventional data, and output both such formats (typically with position information for the frame of second format data) to the device 100.

In a farther embodiment, a device according to an embodiment of the present invention may be a network component, accepting data from multiple computing devices or other sources and transferring the data to one or more monitors capable of accepting such data. In such a case, the device may accept data from only one source, possibly convert or manipulate the data, and transmit the data to a monitor. Such data transfer may be done via network. In such a case, the device may accept and combine more than one data format, as described above.

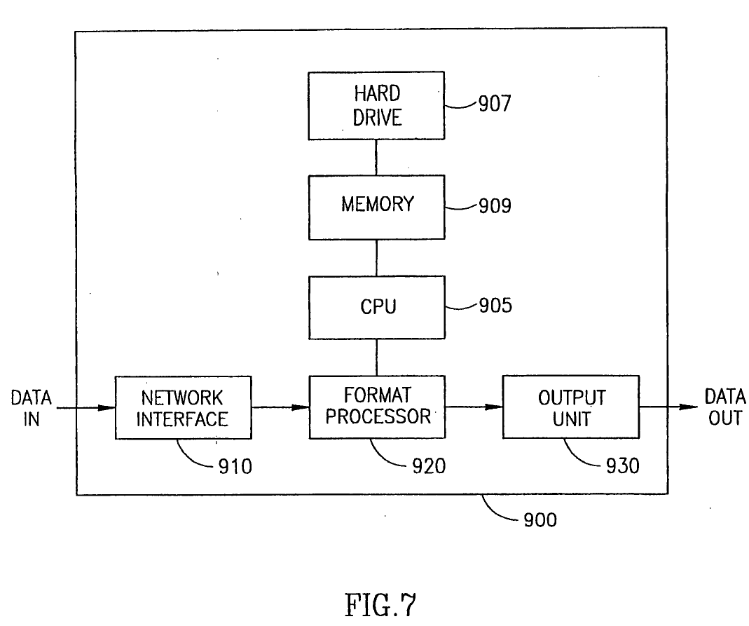

FIG. 7 depicts a device according to one embodiment of the present invention. In one embodiment, device 900, including the various units depicted in FIG. 7, are implemented as part of a personal computer, workstation, or other system, containing traditional computer subcomponents such as a disk drive, processor, memory, etc. In such a case, all or some of the units may be implemented in hardware, and all or some of the units may be implemented in software. For example, a software program running under the control of the processor of the personal computer may perform the functions of some or all of the units depicted in FIG. 7. In another embodiment, such units may all be in a card or processing system, such as a card or chip that may be inserted into a personal computer, workstation, or other system.

Referring to FIG. 7, device 900 includes a unit or units capable of inputting and/or processing graphics data, typically in a format intended to be displayed with more than three primaries, although other formats may be used. Controller 905 controls the overall operation of device 900. In one embodiment, controller 905 is the central processing unit of a personal computer or workstation, in alternate embodiments controller 905 may be implemented in other manners, and the control function may be spread among several devices or components. Network interface 910 enables the transfer of data to the device 900. In one embodiment, such data is CMYK data. Network interface 910 may be, for example, a network card on a personal computer or workstation. In alternate embodiments, other methods of transferring data to device 900 may be used; for example, a direct connection to the data bus of a personal computer or workstation. Optionally, device 900 may include components traditionally associated with a personal computer or workstation, such as a hard drive 907 or memory system 909.

Format processor 920 converts the input data to data suitable for the relevant monitor. In one embodiment, such a conversion is from source data, such as CMYK data, to a set of primary levels suitable for an n>3 primaries display, as described above; in other embodiments, other data formats may be used. Alternately, such data conversion may be performed in the monitor itself. The data is sent to an output unit 930 for transfer to the appropriate monitor. In one embodiment, output unit 930 is a USB adapter, transferring data according to the USB format. In another embodiment, the data may be transferred using the network interface 910. The monitor receiving such data may have, typically, a data receiving unit (such as a USB unit), and need only require a limited controller which essentially loads inputted primaries data to a frame buffer and formatter. In alternate embodiments, such a monitor may include additional processing.

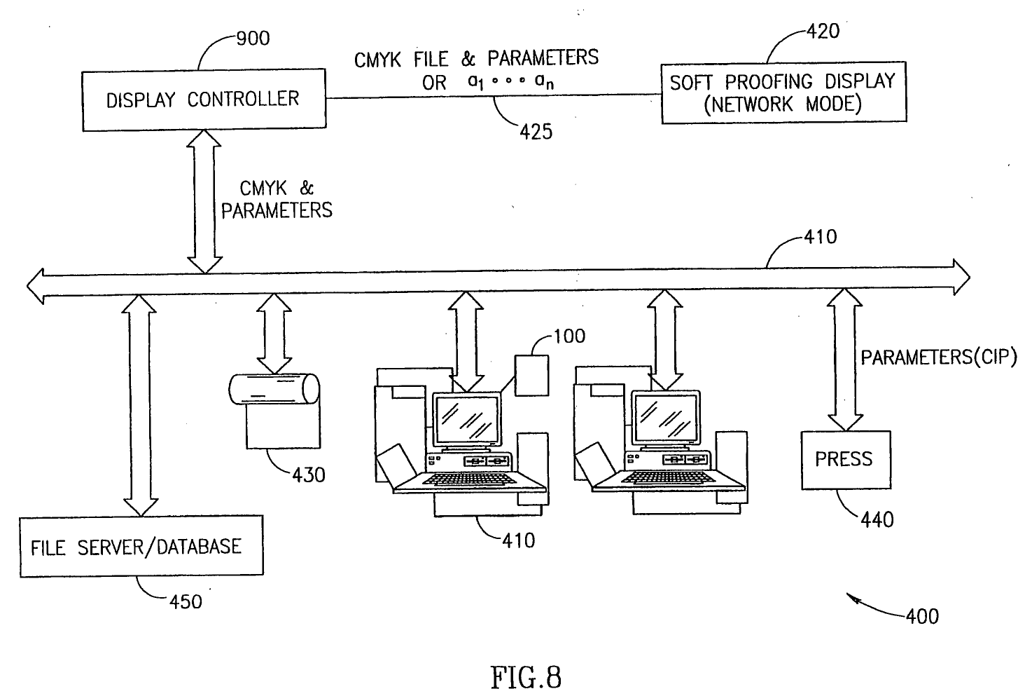

FIG. 8 depicts an embodiment of a network that may be used with devices according to an embodiment of the invention. Referring to FIG. 8, a network 400, operating according to known methods, connects and transfers data among various items of equipment, such as personal computers or workstations 410, via a data transfer conduit 402. Network 400 is typically a local area network, but may be other types of networks, such as wide area networks or the Internet. Attached to or included within network 400 are devices 100 and 900, and printer 430. A press 440 may transfer, for example, print process data, via the network 400. A file server or database 450 may provide mass storage. A device 100 is attached to one of personal computers or workstations 410 for local display of more than one format of data. Device 100 accepts display data of different formats and output such data to monitors, as described above.

Typically device 900 accepts display data in one format and outputs such data to, for example, monitor 420, as described above; however, device 900 may accept and manipulate more than one format of data, as with device 100. N>3 primaries monitor 420 typically uses more than three primary colors to display images, as described above. As described above, device 900 and monitor 420 may communicate through various methods, such as a USB connection 425 or other connections, such as a serial connection or a parallel connection. Personal computers or workstations 410 may be personal computers or workstations as known in the art, operating software such as, for example, Adobe Photoshop™ or operating systems such as, for example, Windows™. Each of personal computers or workstations 410, n>3 primaries monitor 420, de-vice 900, and printer 430 may include conventional network interface equipment and software (not shown).

Software operating at personal computers or workstations 410 may generate video data in more than one format, such as a conventional RGB format and a second format intended for n>3 primaries display. Such data may be displayed on conventional monitors associated with personal computers or workstations 410, in such case, the n>3 primaries data may be displayed using conventional technology, and the full color gamut may not be viewed. A device 100 attached to one of personal computers or workstations 410, may be used to combine and manipulate such data for local display.

Software may transfer (for example per a user command) display data to device 900, which, as described above, may manipulate the data and transfer the data to n>3 primaries monitor 420. Data transfer between personal computers or workstations 410 and local monitors is typically at high speed, for example via the DVI format. Data transfer between the network based device 900 and the n>3 primaries monitor 420 may be via a slower data transfer method, such as via USB connection 425. In an alternate embodiment, monitor 420 need not be an n>3 primaries monitor. For example, the system described in FIGS. 4 and/or 7 may be used to allow more than one format of display data to be displayed on a monitor; such a monitor may be a conventional RGB monitor.

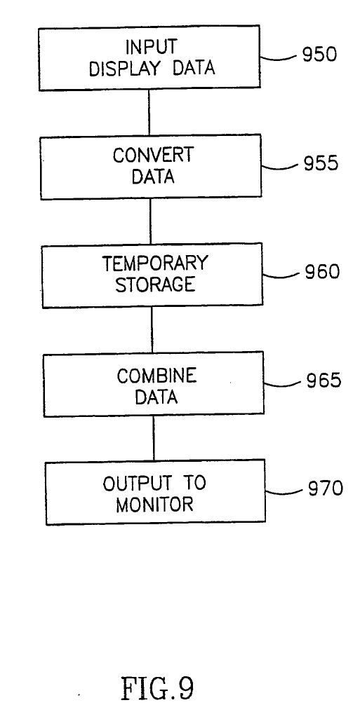

Reference is made now to FIG. 9, which is a flow chart illustration of a method of combining data of a plurality of formats in accordance with an embodiment of the present invention.

Two or more data signals of a plurality of formats may be input to a device 100 (which may be, for example, a graphics card, a personal computer, etc.) (step 950), for example the device 100 may be input with a first signal in a non n>3 primaries format and a second signal in a format intended for n>3 primaries display. According to some embodiments of the present invention the non n>3 primaries format may be conventional RGB format data, and according to yet further embodiments the n>3 primaries data may be CMYK data.

One or more of the plurality of data signals may be undergo conversion to a format or suitable for display by a monitor (step 955). For example, in case one of the data signals is in a low gamut format, and the display unit upon which the data is to be displayed is an n>3 primaries display, the device may convert the data to a set of display primary levels suitable for an n>3 primaries display. In alternate embodiments, no data conversion need be performed.

According to some embodiments of the present invention a conventional RGB data signal may be input to the device and the device may convert the data signal to, for example n>3 primaries data. In other embodiments, non-RGB data may be converted. According to some embodiments of the present invention source data intended for n>3 primaries display, such as CMYK may be converted to a set of display primary levels suitable for such a display. In other embodiments, other data formats may be used.

One or more of the plurality of data signals may be transferred to one or more storage mediums for temporal storage (block 960). Such a storage medium(s) may be for example, a memory.

The plurality of data signal may be combined (block 965). Typically, the combination is performed by a frame combiner, which forms one frame of data per each display cycle of a monitor. According to some embodiments of the present invention one or more predefined display unit parameters, for example the refresh rate of the display, may affect the combination of the display data. According to some embodiments of the present invention one or more of the input data signals may include position data. The position data may determine where, within the overall display field of the display unit, the data may be displayed. According to one exemplary embodiment of the present invention the plurality of data formats may be combined to form a raster pattern. The plurality of the data formats may be combined by modulating each of the data formats to be displayed in the time domain such that a raster pattern including interleaved plurality of data formats may be generated. According to some embodiments of the present invention the raster pattern is formed in accordance with in predefined display characteristics, such as resolution and refresh rate.

A control signal may be generated and the control signal may be capable of instructing the display what portion of which data format should be generated for display or at which point the data is output in one format as opposed to a second format. In other embodiments more than one control signal may be used.

The raster pattern may be output to a display monitor (step 970) for display.

In alternate embodiments, other steps and other sequences of steps may be used. For example, two data formats need not be combined.

It will be further appreciated that the present invention is not limited by what has been described hereinabove and that numerous modifications, all of which fall within the scope of the present invention, exist. Rather the scope of the invention is defined by the claims, which follow:

What is claimed is:

1. A method of inputting data in at least two formats and outputting the data to a monitor, the method comprising:
inputting a first set of graphics data in a first format;
inputting a second set of graphics data in a second format; and
outputting the data to a monitor capable of displaying more than three primaries.

2. The method of claim 1, comprising combining the first and second sets of data.

3. The method of claim 1, comprising:
outputting the first set of data during a first period of time; and
outputting the second set of data during a second period of time.

4. The method of claim 1, comprising outputting a control signal describing whether the first set of data or the second set of data is being output.

5. The method of claim 1, comprising processing the data before outputting the data.

6. The method of claim 5, wherein the processing includes at least converting at least one of the sets of data from one format to another format.

7. The method of claim 1, wherein the data is output in a faster format, and wherein each pixel of each line is output as either data from the first set of data or data from the second set of data.

8. The method of claim 1, comprising accepting a frame parameter and, according to the frame parameter, outputting the second set of data so that the second set of data appears in a frame according to the frame parameter.

9. The method of claim 1, wherein the first set of data describes three primary data and the second set of data describes more than three primary data.

10. The method of claim 1, wherein the monitor is capable of outputting images based on the first set of data and the monitor is capable of outputting images based on the second set of data.

11. A device accepting data in at least two formats and outputting the data to a monitor, the device comprising:
a first input unit capable of inputting a first set of graphics data in a first format;
a second input unit capable of inputting a second set of graphics data in a second format; and
an output unit capable of outputting the data to a monitor capable of displaying more than three primaries.

12. The device of claim 11, comprising a frame combiner.

13. The device of claim 11, comprising a set of output data lines, wherein both the first and second set of graphics data may be output on at least the same subset of the set of output data lines.

14. The device of claim 11, comprising a control line capable of providing a signal indicating which of the first and second set of data are being output.

15. The device of claim 11 comprising a conversion unit capable of converting the data from one format to another format.

16. The device of claim 1, wherein the first set of data describes three primary data and the second set of data describes more than three primary data.

17. The device of claim 1 wherein the monitor is capable of producing a display based on the first set of data and the mnonitor is capable of producing a display based on the second set of data.

18. The device of claim 11, comprising a disk drive.

19. A network comprising:
a data transfer conduit; and
the device of claim 11.

20. A method of inputting data and outputting the data to a monitor, the method comprising:
inputting a set of graphics data from a data network, the data transmitted by one of a plurality of devices communicating with said data network;
converting the set of graphics data; and
outputting the data to a monitor capable of using more than three primaries.

21. The method of claim 20, comprising inputting a second set of graphics data and combining the set of graphics data and the second set of graphics data.

22. The method of claim 20, comprising converting the second set of graphics data from one format to another format.

23. The method of claim 20, wherein the data is output via a serial connection.

24. The method of claim 20, wherein the data is output via a parallel connection.

25. The method of claim 20, wherein the data is output via a USB connection.

26. The method of claim 20, wherein the set of graphics data describes CMYK data.

27. A device comprising:
a network input;
an output Unit capable of outputting data to a monitor capable of using more than three primaries; and
a controller capable of inputting a set of graphics data via the network input the data transmitted by one of a plurality of devices communicating with said data network, the controller capable of converting the set of graphics data.

28. The system of claim 277 wherein the controller is capable of inputting a second set of graphics data and combining the set of graphics data and the second set of graphics data.

29. The system of claim 27, wherein the output unit includes a serial connection.

30. The method of claim 27, wherein the output unit includes a parallel connection.

31. The system of claim 27, wherein the output unit includes a USB unit.

32. The system of claim 27, wherein the set of graphics data describes CMYK data.

33. The system of claim 27, comprising a disk drive.

34. A network comprising:
a data transfer conduit; and
the device of claim 27.

35. A method of inputting data in at least two formats and outputting the data to a monitor, the method comprising:
accepting a set of graphics data in a first format;
accepting a second set of graphics data, the second set of graphics data describing CMYK data; and
transmitting the data to a monitor.

36. A method of inputting data in at least two formats and outputting the data to a monitor, the method comprising:
accepting a set of graphics data in a first format;
accepting a second set of graphics data in a second format;
combining the first and second sets of data to an output format including information on more than three primaries; and
transmitting the data.

37. A device accepting data in at least two formats and outputting the data to a monitor, the device comprising:
a first input means for inputting a first set of graphics data in a first formal;
a second input means for inputting a second set of graphics data in a second format; and
an output means for outputting the data.

38. A device accepting data in at least two formats and outputting the data to a monitor, the device comprising:
a first input unit capable of inputting a first format of graphics data;
a second input unit capable of inputting a second format of graphics data;
a frame combiner; and
an output unit.

39. A device accepting data in at least two formats and outputting the data to a monitor, the device comprising:
a first input unit capable of inputting a first format of graphics data;
a second input unit capable of inputting a second format of graphics data;
a conversion unit in communication with the first and second units and capable of converting data from one format to another format; and
an output unit capable of outputting data to a monitor.

40. A method of inputting data and outputting the data to a monitor, the method comprising:
inputting a set of graphics data, the data transmitted by any of a plurality of devices communicating via a data network;
converting the set of graphics data; and
outputting the data via a USB connection to a monitor capable of using more than three primaries.

41. A method of inputting data and outputting the data to a monitor, the method comprising:
inputting a set of CMYK data, the data transmitted by any of a plurality of devices communicating via a data network;
converting the set of graphics data to a format suitable for a monitor using more than three primaries; and
outputting the data.

42. A device comprising:
a network input;
an output means for outputting data to a monitor capable of using more than three primaries; and
a controller means for inputting a set of graphics data from the network input, the data transmitted by any of a plurality of devices communicating with said data network, and converting the set of graphics data.

43. A device comprising:
a network input;
a controller capable of inputting a set of graphics data via the network input, and capable of converting the set of graphics data; and
a USB connection capable of outputting the data to a monitor.

44. A device comprising:
an input accepting data from a network;
a controller capable of inputting a set of CMYK data via the network input, and capable of converting the set of CMYK data to data suitable for a monitor capable of using more than three primaries; and
an output unit capable of outputting data to the monitor.

45. A device accepting data in at least two formats and outputting the data to a monitor, the device comprising:
a first input means for inputting a first set of graphics data in a first format:
a second input means for inputting a second set of graphics data in a CMYK format; and
an output means for outputting the data.

46. A device accepting data in at least two formats and outputting the data to a monitor capable of displaying more than three primaries, the device comprising:
a first input unit capable of inputting a first format of graphics data;
a second input unit capable of inputting a second format of graphics data;
a frame combiner; and
an output unit.

47. A device accepting data in at least two formats and outputting the data to a monitor, the device comprising:
a first input unit capable of inputting a first format of graphics data;
a second input unit capable of inputting a second format of graphics data;
a conversion unit in communication with the first and second units and capable of converting data from one format to another format; and
an output unit capable of outputting data to a monitor.
